(19) United States
(12) Patent Application Publication
(10) Pub. No.: US 2020/0141876 A1
(43) Pub. Date: May 7, 2020

(54) Gas Detector Tube Kit and Methods of Reading Gas Detector Tubes

(71) Applicant: Nextteq LLC, Tampa, FL (US)

(72) Inventor: Bryan I. Truex, Tampa, FL (US)

(73) Assignee: Nextteq LLC, Tampa, FL (US)

(21) Appl. No.: 16/178,787

(22) Filed: Nov. 2, 2018

(51) Int. Cl. G01N 21/78; G01N 21/29

(52) U.S. Cl. CPC G01N 21/783; G01N 2021/7796; G01N 21/293

(57) ABSTRACT

Gas detector tubes kits are described. Gas detector tubes may be used to determine the concentration of target gases and/or interferent gases in a sampled gas either visually or electronically.

### FIELD OF THE INVENTION

The invention relates to gas detector tubes, apparatuses, kits, and devices for reading gas detector tubes, and methods of reading gas detector tubes. Embodiments of the apparatuses, kits, and devices are capable of being used for detecting and determining an approximate concentration of at least one target compound and/or an interferent gas in a sampled gas mixture. Gas detector tubes, typically, comprise a transparent tube containing a chemical reagent capable of changing colors when contacted by a target compound or class of target compounds. The apparatuses, systems and methods allow convenient reading, converting and/or interpreting the colorimetric change of the chemical reagent to determine the concentration of the target compounds and/or compounds that interfere with the reading of the target compound (hereinafter “interferent compounds”) in the sampled gas.

After sampling of the environment by passing a gas mixture comprising the target gas or interferent compounds through the gas detector tube, the resulting color change may be manually or electronically measured as a length-of-stain. The length-of-stain may be correlated to a concentration of a target gas or interferent gas by measuring the degree that a chemical reagent has undergone a color change by chemical reaction and the volume of sample drawn through the gas detector tube. In embodiments of the gas detector tube, the length-of-stain and/or color change may be determined visually by comparing the length of stain to demarcations on a scale printed on the gas detector tube, on a scale card comprising demarcations associated with a detector tube, by a calibrated optical reader, or electronic gas detector tube reader programmed with length of stain curves and, optionally, additional information concerning both the target gas and the interferent gas.

### BACKGROUND OF THE INVENTION

There are a variety of apparatuses for measuring the concentration of certain gaseous components of a gas mixture. Simple apparatuses, referred to as gas detector tubes, colorimetric tubes, or gas indication tubes (“gas detector tubes”), typically comprise a transparent tube and a chemical reagent within the transparent tube that can react with a target chemical compounds resulting in a color change of the reagent. In a typical colorimetric gas detector tube, a known volume of air or sampled gas is passed through the tube with a pump or other device. The chemical reagent indicates the presence of target compounds by changing color beginning at the inlet end of the tube as the target gas reacts with the chemical reagent. The chemical reagent continues to change color lengthening the length-of-stain as long as the target gas or the interferent gas is passing through the gas detector tube. The resultant length-of-stain (the length of the color changed section of the chemical reagent) depend on the concentration of the target compounds and the volume of gas which have passed through the tube. Colorimetric gas detector tubes are used throughout industry as a low-cost and easy-to-use tool for detecting the presence of target compounds in a sampled volume of gas. The tube is, typically, made of glass, polycarbonate, or another transparent material, for example, so that the length-of-stain may be seen and measured.

For example, conventional gas detector tubes comprise a glass tube filled with a chemical reagent that reacts to a specific target chemical compounds. The chemical reagent is sealed within the glass tube and retained in a defined position between two gas permeable plugs in both ends of the glass tube. In some cases, the chemical reagent may be liquid impregnated into a porous chemically neutral solid substrate. Prior to use, the chemical reagent is protected from exposure to contaminants and chemical compounds by sealing the ends of the gas detector tubes to form breakable tips until use, thereby extending the shelf life of the gas detector tube prior to use. To use the gas detector tube, the tips on both ends of the detector tube are broken off to open a gas flow path through the tube and across the reagent. The air or other gas to be sampled may then be drawn through the tube and into contact with the reagent in a fixed volume of a sample drawn through a volumetric sampling pump, for example. The reagent is capable of rapidly reacting with the target compounds as the sample is drawn through the tube. The amount of reaction and the degree of change of color of the reagent are related to the concentration of the target chemical compounds in the sampled gas, the amount of reagent in the tube, the flow area of the gas tube, and the volume of gas drawn through and across the reagent, for example. Since the sampled gas is drawn in one end of the gas detector tube and out the other end, the reagent begins to change color at the inlet end and the color change extends toward the outlet producing the “length-of-stain.”

To determine the concentration of a target compound, a known volume of the sample gas may be drawn into the gas detector tube comprising a known quantity of reagent that reacts in a repeatable manner resulting in a color change with target compounds. After sampling, the length-of-stain should correlate to the only unknown variable, the concentration of the gas. The length of the color change and the degree of color change of the reagent then corresponds to the concentration of the target compounds. Detector tubes that measure gas concentration by length-of-stain are reliable and simple to use after training.

To ensure more accuracy in measuring the concentrations of target gases, after manufacturing a batch of gas detector tubes, fixed volumes of gas with known concentrations of target compounds are passed through the gas detector tubes to develop a batch specific calibration curve relating the length-of-stain to a corresponding gas concentration. The calibration curve is included with the detector tube to allow visual reading of the concentration of a gas in a sampled volume.

Gas detection tubes are generally quite selective, but some interferent compounds may interfere with accurate measurement of a target gas concentration. The length of stain of the gas detector tube reagent can be either lengthened or shortened when both the target gas and the interferent gas are in the sampled gas mixture. The instructions accompanying the gas detector tube should list possible interferent compounds. In addition, other interferent compounds may also exist. As stated, in most cases the interferent compounds increase the stain length thereby erroneously indicating that the concentration of target gas in the gas mixture is higher than it actually is, but in some cases the interferent gas may decrease the stain length. The user must not only be aware of potential interferent compounds for a gas detector tube but also whether the sampled gas mixture may comprise interferent compounds or incorrect gas concentrations may reported and actions taken that may not have been necessary if correct readings were measured. The presence of interferent compounds may lead to dangerously inaccurate gas detector tube readings.

There exists a need for an apparatus, kit, device, and method for using gas detector tubes for reading either target compounds or interferent compounds.

### SUMMARY

Gas detector tubes may be used to determine the concentration of target gases in a sampled gas. Traditionally, gas detector tubes have been read visually by comparing the length-of-stain of the reagent to calibration demarcations printed or etched on the transparent tube. However, the concentration of the target gas may be determined by an electronic tube reader that are capable of reading a length-of-stain with optical image technology and converting the length-of-stain to a concentration of target compounds by using a calibration curve stored in memory. Electronic tube readers are preferably used with gas detector tubes that comprise a transparent tube without concentration demarcations in a working area that interfere with a clear view of the reagent.

As previously stated, gas detector tubes contain a chemical reagent that reacts with any target gas in a sampled gas. However, if the sampled gas also comprises an interferent gas that also reacts with the chemical reagent, the length-of-stain will not accurately correlate to the concentration of the target because of the two simultaneous competing reactions. However, since the interferent gas also reacts with the chemical reagent in a colorimetric reaction, he gas detector tube may be used to determine the concentration of the interferent gas in a sample gas that does not comprise a significant amount of the target gas.

Therefore, an embodiment of a gas detector tube kit comprises a transparent gas detector tube containing a colorimetric chemical reagent within the transparent gas detector tube, wherein the colorimetric chemical reagent is capable of reacting with at least one of either a target gas or an interferent gas to change the color of the colorimetric chemical reagent thereby producing a length of stain within the transparent tube. For an environment without significant concentrations of the interferent gas, the gas detector tube may be used to read concentrations of the target gas. Alternatively, for an environment without significant concentrations of the target gas, the gas detector tube may be used to read concentrations of the interferent gas. In either case, the length of stain present after sampling will correspond to a concentration of either the target gas or the interferent gas in a sample.

The gas detector tube kit may comprise a target gas length-of-stain scale to determine a concentration of the target compound in a sampled gas comprising the target gas for use with the gas detector tube and/or an interferent gas length-of-stain scale to determine a concentration of the interferent compound in a sampled gas comprising the interferent gas for use with the gas detector tube.

The target gas length-of-stain scale and the interferent gas length-of-stain scale may be electronically stored length of stain correlations or physical length-of-stain scales for visually determining the concentration of either the target gas or the interferent gas.

Embodiments of a gas detector tube kit may comprise a template that may be used to accurately and reliably read gas detector tubes that do not have concentration demarcations printed on the tube. In one embodiment, the gas detector tube template comprises a gas detector tube holder capable of reversibly receiving a gas detector tube and at least one scale card holder. The template may be a template described in U.S. patent application Ser. No. 15/062,891 which is hereby incorporated by reference.

The gas detector tube template may be used with a scale cards capable of being reversibly received in a scale pocket, wherein the scale card comprises a first set of demarcations for interpreting a length-of-stain for a target compound in the gas detector tube. The scale card may further comprise a second set of demarcations for interpreting a length-of-stain for a target compound in the gas detector tube on a second side. In other embodiments, the gas detector tube kit may comprise a plurality of scale cards. For example, a first scale card may be used for a first volume of gas passed through the gas detector tube for a specific target compounds and the second set of demarcations may be used for a second volume of gas passed through the gas detector tube for the specific target compounds. In another embodiment, the first set of demarcations may be for a target compound and the second set of demarcations for an interferent compound.

The terminology used herein is for the purpose of describing embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

### BRIEF DESCRIPTION OF THE DRAWINGS

FIGS. 1A, 1B and 1C depict conventional gas detector tubes.

### DESCRIPTION

Gas detector tubes may be used to accurately and repeatedly determine the concentration of target gases in a sampled gas. Traditionally, gas detector tubes have been read visually by comparing the length-of-stain of the reagent exposed to its corresponding target compounds within the gas detector tube to a calibration curve printed on the transparent tube. However, more recently, electronic tube readers are capable of reading a length-of-stain by optical image technology and convert the length-of-stain to a concentration of target compounds by using a calibration curve stored in memory. The gas detector tubes may comprise a transparent tube without concentration demarcations that may interfere with a complete view of the reagent for either visual or electronic reading of the length-of-stain.

As used herein, the term “transparent tube” means the tube of the gas detector tube is made of a transparent or semitransparent material in the working area and has no demarcations or obstructions in the working area of the tube that significantly interfere with viewing or electronically reading the length-of-stain of the chemical reagent.

As used herein, the term “working area” is the area used for viewing or electronic reading the length-of-stain between its minimum concentration reading and its maximum concentration reading through the readable range.

As used herein, the term “interferent gas” means a gas that is considered to interfere with the reading of the target gas for a gas detector tube.

Gas detector tubes are typically manufactured with a specific chemical reagent to determine the concentration of at least one target gas, family of target gases comprising a similar functional group, or class of target gases (collectively “target gas”) in a sample gas. Typical chemical reagents for gas detector tubes comprise porous solid particles having a chemical reagent on the surface of the porous solid particles with pathways between the particles that allow gas to flow through and between the porous solid particles from an inlet of the gas detector tube to an outlet of the gas detector. The chemical reagent will change color as it comes in contact with the target gas and/or an interferent gas through a colorimetric reaction. In this case, the colorimetric reaction comprises the chemical reagent reacting with the target gases resulting in the color change of the chemical reagent. As a sample passes through the gas detector tube, the target gases are involved in the colorimetric reaction with the chemical reagent until the target gases are depleted from the sampled gas. Many reagents for use in gas detector tubes are known and applicable to embodiments of the gas detector tubes. A sample is typically drawn through the gas detector tubes by a sampling pump to initiate the colorimetric reaction and determine the concentration of the target gas. Common sample pumps include hand-held piston pumps or bellows pump that are capable of accurately and repeatedly drawing a known volume of air.

Typically, the chemical reagent is fixed in place within the tube by two porous solid plugs at either end of the reagent within the tube. As the sample gas comprising target gases is drawn through an inlet of the gas detector tube, the chemical reagent near the inlet will begin to change color and, if the concentration of the target gases is within the readable concentration range of the gas detector tube, the chemical reagent near the exit of the tube will remain unchanged. The length of the color change of the reagent (“length-of-stain”) within the tube will correspond to the total amount of the target gases that were passed through the gas detector tube. If a known volume of gas is passed through the tube, a concentration of the target gases may be determined. Conventional gas detector tubes have a scale printed on the glass tube over the chemical reagent that may be used to approximate the concentration of the target gases for a known volume of the sampled gas. Each gas detector tube will have a readable concentration range for the target gases, if the gas concentration range is exceeded for a volume of sample, the chemical reagent will change color throughout its entire length and a concentration of the target gas may not be conventionally determined or if the concentration of the target gas is too low, the chemical reagent may not record a sufficient color change to determine the concentration of target gases. In such cases, a different tube with the appropriate concentration range may be used or the volume of sampled gas may be increased or decreased to produce a reading within the scale. For some gas detector pump and gas detector tube systems, only up to a five-fold increase in sampled volume is recommended. The scale of the gas detector tube must then be adjusted to account for the different sample volume as the demarcations as printed on the gas detector tube may not accurately indicate the concentration of the target gas in the sample.

Gas detector tubes may be read either electronically by an electronic gas detector tube reader or visually by a user by a simple comparison of the length-of-stain with one or more scales inserted into a gas detector tube template.

To improve optico-electronically reading and the versatility of gas detector tubes, gas detector tubes without any demarcations printed on the transparent portion of the tube in the working area of the gas detector tube may be produced. Therefore, some gas detector tubes, preferably, do not have a scale printed, etched or otherwise applied to it over the chemical reagent. The tubes without demarcations may be more difficult to read, however, these become tubes more versatile with the proper tools and/or accessories.

Concentration demarcations on the gas detector tube are generally calibrated to 100 ml of the sampled gas. Gas detector tube pumps are standardized to standard gas detector tube pumps that draw 100 ml in one pump stroke. Some gas detector tube concentrations are calibrated to 200 ml or 300 ml (two or three pump strokes). If the target gas is present in the sampled gas in concentrations lower than the lowest graduation on the detector tube, the approximate concentration value may be determined by increasing the sample volume and adjusting the concentration value read on the detector tube by a correction factor. This process however, may be subject to operator error.

Therefore, gas detector tube comprising the same chemical reagent are prepared for use with different concentrations of the same target gas. The detector tubes may have different amounts of chemical reagent within the gas detector tube so that lower concentrations of the target gas create a longer, more easily readable length of stain, for example. Thus, the concentration demarcations are different for each tube based upon the amount of chemical reagent within the tube and the number of pump strokes required to accurately determine a gas concentration, for example. Therefore, embodiments of the gas detector tube kits may have target gas scales for different volumes of sampled gas, different number of pump strokes, different target compounds, or interferent gases.

Additionally, the chemical reagents within the gas detector tubes will eventually deteriorate over time and/or on exposure to high temperatures, for example. Thus, gas detector tubes have a limited shelf life and should not be used after their expiration date or they may not show an accurate gas concentration in the sampled gas.

Although care is taken in choosing the appropriate colorimetric chemical reagents in gas detector tubes and the reagents are carefully formulated to react uniquely with one specific target gas or class of target gases, the chemical reagents may, in some cases, also exhibit a colorimetric reaction with one or more interferent gas.

An industrial hygienist must carefully consider whether any interferent gases are present when sampling for the concentration of target compounds. The interferent gas may discolor the chemical reagent in addition to the target gas resulting in a reading that could be interpreted as a higher concentration of target gases in the environment than actually are present.

In still further embodiments, the gas detector tube kit may comprise a interferent gas length-of-stain scale wherein the interferent gas length-of-stain scale is used to determine the concentration of an interferent gas. The determination of the concentration of the target gas and the interferent gas may require different volumes of gas to be sampled through the gas detector tube depending on the concentration of the gas in the sampled environment.

In an embodiment for electronic reading of the length of stain, the gas detector tube kit may further comprise an electronic gas detector tube reader comprising an information storage device, wherein the target gas length of stain scale and/or the interferent gas length of stain scale may be stored electronically in the information storage device. In such embodiments, the gas detector tube reader can measure the length of stain in the gas detector tube using an algorithm in conjunction with optical measurement techniques. The length of stain may then be converted to an estimated concentration of gas in the sample with the electronically stored length of stain scale and any stored compensation factors in a processing unit. For example, one or more interferent gas length of stain scales is stored electronically in the information storage device. In some embodiments, two or more interferent gas length of stain scales are stored electronically in the information storage device. For example, the two or more interferent gas length of stain scales may be for reading different concentration ranges of the interferent gas or for different number of pump strokes of the gas detector tube pump.

Thus, the gas detector tube kit may estimate the concentration of the interferent gas and/or the target gas based upon electronic or optical reading of the length of stain. The concentration of the interferent gas may be output, printed, and/or displayed from the gas detector tube reader in at least one of the following units or measure including, but not limited to, percent, parts per million, parts per billion, pounds per million cubic feet, milligrams per cubic meter, and milligrams per liter, for example. The gas detector tube reader may comprise software for switching between the various concentration units.

There may be additional information stored in the information storage device. The additional information may include, but is not limited to, at least one of the name of target gas compound, the target gas compound chemical formula, a scale range and unit of measure the name of the interferent gas, the interferent gas compound chemical formula, concentration range and units of measure of the interferent gas, the molecular weight of the target gas and the interferent gas, a volume of a sample gas per pump stoke, a number of pump strokes required, a correction factor for each concentration range, a sampling time for each concentration range, a detection limit for the gas detector tube, a color change indication, a compensation factor for temperature and humidity, a standard deviation for the concentration determination, a shelf life for the gas detector tube, a reaction principle for the chemical reagent and the target gas, a reaction principle for the chemical reagent and the interferent gas, and an expiration date for the gas detector tube, for example.

In one embodiment, the gas detector tube, the gas detector tube packaging, and/or the gas detector tube instructions may comprise a QR code or bar code for retrieving gas detector tube information. The gas detector tube information may include, but not limited to, the identity of the target gas compound, the target gas compound chemical formula, a manufacturer of the gas detector tube, a part number of the gas detector tube, a lot number of the gas detector tube, a calibration scale of the gas detector tube, a detection limit for the gas detector tube, a unit of measure for the calibration scale, the measurement range of the gas detector tube, an expiration date for the gas detector tube, an environmental operating and storage specifications for temperature, humidity, altitude, barometric pressure, an effect of interferents, and correction factors, a volume of a sample gas per pump stoke, a standard number of pump strokes required, minimum detection limit, a sampling time for each stroke, a standard volume of a sample for the tube, sample time per pump stroke, total sample time, a correction factor for temperature and humidity, a lot specific calibration curve formula, and an identification as to whether the QR code is dynamic or not dynamic, a color change for the target gas including the initial color and the reacted color, a color change for each interferent gas including the initial color and the reacted color, a relative standard deviation for the concentration reading, calibration scale range and unit of measure for each target gas and interferent gas, the identity of each interferent gas and chemical formula, and an effect of each interferent gas, for example.

The gas detector tube reader may comprise various communication devices. In one embodiment, the gas detector tube reader may comprise a USB connection. In further embodiments, the gas detector tube reader may comprise at least one of a bar code reader, a USB connection, WIFI chip, Bluetooth chip, hard-wired ASCII communication port, optical signal reader, and infrared signal reader.

Gas detector tube readers are used to determine the concentration of gases in a sampled environment and at times may be used in the presence of hazardous gases. Therefore, the gas detector tube reader may be at least one of explosion proof and intrinsically safe.

Therefore, an embodiment of the invention comprises a gas detector tube reader system, wherein the gas detector tube reader comprises a transparent gas detector tube containing a colorimetric chemical reagent within the transparent gas detector tube. In this embodiment, the colorimetric chemical reagent reacts with both a target gas and an interferent to change the color of the colorimetric chemical reagent thereby producing a length of stain within the transparent tube. In association with the gas detector tube, the gas detector tube reader system comprises a gas detector tube reader. The gas detector tube reader comprises an information reader capable of identifying the transparent gas detector tube by reading electronic or optically coded tube information describing characteristics of the gas detector tube; color sensor for determining gas detector tube initial color and any color change; an optical reader capable of determining the length of stain in the gas detector tube, a computer memory device, wherein an interferent gas length-of-stain scale to determine a concentration of the interferent compound in a sampled gas from a length-of-stain in the transparent gas detector tube and/or a target gas length-of-stain scale to determine a concentration of the interferent compound in a sampled gas from a length-of-stain in the transparent gas detector tube may be stored in the computer memory device; and a central processing unit in communication with the information reader and the optical reader, wherein the central processing unit is capable of estimating a concentration of target gases based upon output from the information reader and the optical reader. Also, a target gas length-of-stain scale to determine a concentration of the target compound in a sampled gas from a length-of-stain in the transparent gas detector tube may be stored in the computer memory device.

Additional information may be stored in the computer memory device. For example, the additional information may include, but is not limited to, at least one of the target gas compound, the target gas compound chemical formula, a scale, range and unit of measure of the target gas and/or the interferent gas, a volume of a sample gas per pump stoke, a number of pump strokes required, a correction factor for each range, a sampling time for each range, a detection limit for the gas detector tube, a color change indication, a compensation factor for temperature and humidity, a standard deviation for the concentration determination, a shelf life for the gas detector tube, a reaction principle for the chemical reagent and the target gas, a reaction principle for the chemical reagent and the interferent gas, and an expiration date for the gas detector tube.

The transparent gas detector tube, a packaging, or an instruction for the gas detector tube may comprise a QR code or bar code for retrieving tube information. The tube information may be the same as listed above.

Gas detector tubes without concentration demarcations may be used for both target gases and interferent gases and may allow an industrial hygienist to maintain a lower inventory stocking levels of gas detector tubes than stocking gas detector tubes for each different expected concentration while also ensuring that the gas detector tube in inventory will not be expire due to infrequent use of some tubes.

Further, the same inventory of unmarked glass detector tubes can be used in the optical tube reader having a processor or can be read manually with the gas detector tube templates or other printed scales.

The inventors have surprisingly discovered that a gas detector tube comprising a chemical reagent that is intended to be used to detect a target compound may be also used to detect interferent compounds. As stated above, interferent gases may also cause colorimetric change to the chemical reagent in a gas detector tube. For example, if there is an insignificant amount of the target gas in a gas to be sampled, the gas detector tube may be used to determine the concentration of the interferent gas.

Further, embodiments of the invention comprise a gas detector tube kit comprising a gas detector tube comprising a chemical reagent, wherein the chemical reagent is used to detect a target compound. The gas detector tube kit further comprises at least one gas detector tube scale for determining the concentration of the target gas and at least one gas detector tube scale for determining the concentration of the interferent gas. The industrial hygienist or other user may choose the appropriate template for reading either the target gas or the interferent gas.

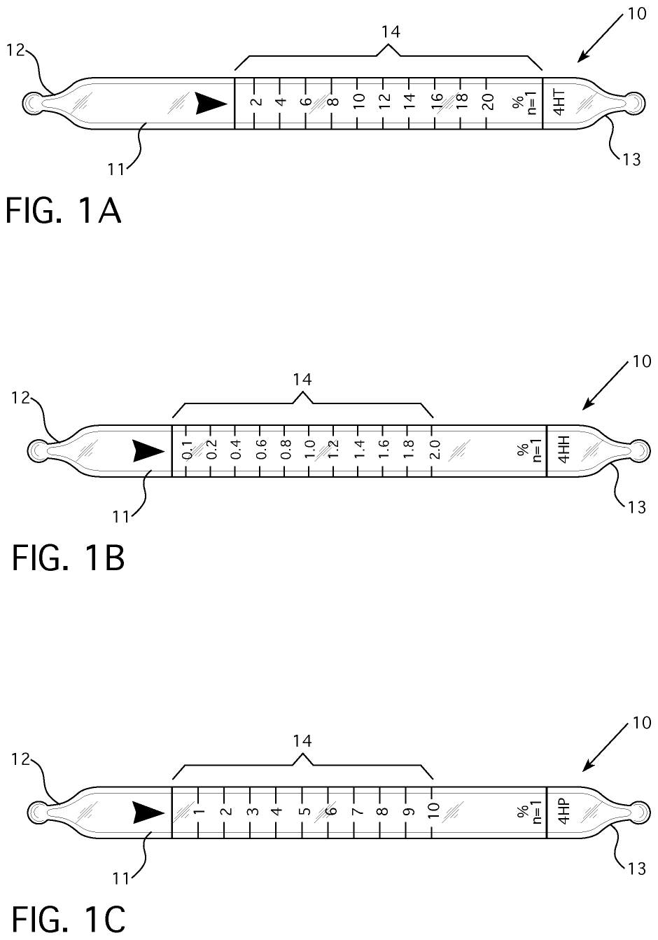

For example, in one embodiment, each gas detector tube kit may comprise 2 to 5 different scales for visual reading of the target compound or interferent gas concentration based upon the volume of sample drawn through the detector tube and the concentration of the target gas. For example, the gas detector tube shown in Figure 1A is designed for use with three different concentration ranges of the target concentration.

The gas detector tubes 10 of FIGS. 1A, 1B and 1C comprise a transparent tube 11. During storage and prior to use, the transparent tube is a sealed with a tip 12 at the inlet end and a tip 13 at the outlet end. As used herein, “tube” means a conduit defining a flow path of any cross-sectional shape. The cross-sectional shape may be circular, oval, rectangular, square, rectangular, polygonal, or any desired cross-sectional shape. The tube may be sealed simply by heating and pinching the ends of the tubes to seal for tips, using caps, septums or other means to seal the tube as understood by one skilled in the art.

Embodiments of the gas detector tubes may comprise a transparent tube 11 made from a glass or transparent plastics such as, but not limited to, acrylic, polycarbonates, copolymers of polyethylene and polypropylene, polyesters as well as other transparent materials. The gas detector tubes may also comprise demarcations 14 corresponding to the percentage of a target gas or the interferent gas in a sample drawn through the gas detector tube based upon the acquired length-of-stain and the volume of the sample drawn through the gas detector tube. As previously stated, additional compensation factors may be used.

For example, for one pump stroke of a standard gas detector tube pump (100 milliliters), the gas detector tube of FIG. 1A may properly indicate a concentration between 2% and 20% of the target compound(s) in the 100-milliliter sample drawn through the tube.

If one pump stroke (n=1) does not produce a length-of-stain indicating that the concentration of the target compound(s) is greater than 2%, an additional pump stroke (totaling two pump strokes, n=2) of 100 milliliters may be drawn through the gas detector tube of FIG. 1A. However, since the demarcations printed on the glass of the gas detector tube are to be used with one pump stroke, the concentration amounts need to be divided by a correction factor to indicate the actual concentration of the target compound(s) in the 200-milliliter sample. Thus, the gas detector tube may properly indicate a concentration less than 2% of the target compound(s) in the 200-milliliter sample drawn through the tube.

Further, if one pump stroke (n=1) produces a length-of-stain indicating that the concentration of the target compound(s) is greater than 20%, the reading cannot be properly interpreted, and the gas detector tube must be discarded. A new similar gas detector tube may be used with a half pump stroke (n=½) of 50 milliliters may be drawn through the new gas detector tube of FIG. 1A. However, since the demarcations printed on the glass of the gas detector tube are too be used with one 100 milliliter pump stroke (n=1), the concentration amounts need to be multiplied by a correction factor to indicate the actual concentration of the target compound(s) in the 50-milliliter sample. Thus, the gas detector tube may properly indicate a concentration greater than 20% of the target compound(s) in the 50-milliliter sample drawn through the tube.

To improve optico-electronically reading of gas detector tubes, gas detector tubes without any demarcations printed on the transparent portion over the chemical reagent in the working area is recommended. Therefore, some gas detector tubes, preferably, do not have a scale printed, etched or otherwise applied to it. The same detector tubes that are to be read manually are the same detector tubes that can be used in an electronic tube reader ensuring lower inventory stocking levels plus ensuring greater assurance that the inventory will not be obsolete. The same inventory of unmarked glass detector tubes can be used in the tube reader or can be read manually with the gas detector tube template and the printed scales (front and back) on the scale cards that are provided with each box of detector tubes. In addition, additional scale cards could be provided for the same tube increasing the number of applications that can be measured with a single tube part number.

One or more sets of scale cards could be designed for use with each gas detector tube. Embodiments of a gas detector tube kit would comprise a gas detector tube including a specific chemical reagent and several scale card included in each box of gas detector tubes such that the value of the discoloration layer of an activated detector tube could be read with an electronic tube reader without demarcations or the detector tube may be read manually in the event the tube reader had dead batteries or had some other problem by using the gas detector tube template with the appropriate scale cards.

An example of two scale cards with scales printed on both sides is shown below. A first scale card has a front side A and a back-side B for a target compound and a second corresponding scale card for insertion in a second wing has a front side C and a back-side D for interpreting the length-of-stain for the interferent gas.

TABLE 1

| A | | B | | C | | D | |
|---|---|---|---|---|---|---|---|
| Front Side | | Back Side | | Front Side | | Back Side | |
| 10 | ppm | 5 | ppm | 10 | ppm | 5 | ppm |
| 5 | ppm | 1 | ppm | 5 | ppm | 1 | ppm |
| 2 | ppm | 500 | ppb | 2 | ppm | 500 | ppb |
| 0 | ppm | 250 | ppb | 0 | ppm | 250 | ppb |
| 500 | ppb | 125 | ppb | 500 | ppb | 125 | ppb |

| | |
|---|---|
| First scale card front and back | Second scale card front and back |

In a sampling area without a significant amount of the target gas the gas detector tube may be used to detect the interferent gases. Gas detector tube templates or electronically stored calibration information for electronic reading of the interferent gas concentration may be used to determine the concentration of the interferent gases. The tube reader shall provide the ability to apply one or more difference electronic scales, ranges, and units of measure to the detector tube to use the same detector tube to detect and measure one or more difference substances including but not limited to the specific detection and measurement of one or more of the interferent gases. Each cross interferent gas detected and measured by its unit of measure, scale, and range by the tube reader may be identified by the original part number followed by a dash and a number that will specify the detection and measurement of the interferent gas, for example. In one embodiment, the detector tube used with the Tube Reader will have one or more of the following printed or affixed to the detector tube:

(1) Scale

(2) Range

(3) Detection limit

(4) Unit of measure

The battery pack for the Tube Reader may be certified by the following as explosion proof and/or intrinsically safe by Factory Mutual (FM), Underwriters Laboratory (UL). SA Group (Canadian Standards Association Group), OSHA (Occupation Safety and Health Administration), CENELEC (European Committee for Electrotechnical Standardization), or Safety Instrument Systems, IEC61508, IEC61511, ANSI-84.00, EN 50402 Functional Safety of Electrical Apparatus for the detection and measurement of combustible or toxic gases, ANSI/ISA-60079-0 Electrical Apparatus for use in Class 1, Zone 0, 18-2 Hazardous (Classified locations general requirements), IEC 1010-1-General Safety Requirements for electrical equipment for measurement, control, laboratory use, IEC79-Electrical Apparatus for explosive gas atmosphere. IEC International Electrotechnical Commission, IEEX-ATEX (Explosive Atmosphere) Class I, II, III Division I, ATEX-Equipment Directive 94/9/EC, ATEX-Equipment Directive 20134/34/EU, Safety Instrument Systems IEC 61508, Safety Instrument Systems IEC 61511, ANSI-84.00, EN 50402 Functional Safety of Electrical Apparatus for the detection and measurement of combustible or toxic gases, ANSI/ISA-60079-0 Electrical apparatus for use in Class 1, Zone 0, 1 & 2 hazardous (classified) locations, general requirements, Electronic Code of Federal Regulations Title 3-Mineral Resources; Chapter 1, Mine Safety and Health Administration, USA Department of Labor, Subchapter B-Testing Evaluation and Approval of Mining Products, Part 22, or the Electronic Code of Federal Regulations Title 3-Mineral Resources; Chapter 1, Mine Safety and Health Administration, USA Department of Labor, Subchapter b-Testing Evaluation and Approval of Mining Products, Part 23, for example.

The concentration of interferent gas may be determined using an electronic tube reader and applying the desired scale and compensation factors electronically for the interferent gases.

The embodiments of the described gas detector tubes, gas detector tube readers and methods are not limited to the particular embodiments, components, method steps, and materials disclosed herein as such components, process steps, and materials may vary. Moreover, the terminology employed herein is used for the purpose of describing exemplary embodiments only and the terminology is not intended to be limiting since the scope of the various embodiments of the present invention will be limited only by the appended claims and equivalents thereof.

Therefore, while embodiments of the invention are described with reference to exemplary embodiments, those skilled in the art will understand that variations and modifications can be affected within the scope of the invention as defined in the appended claims. Accordingly, the scope of the various embodiments of the present invention should not be limited to the above discussed embodiments and should only be defined by the following claims and all equivalents.

1. A gas detector tube kit, comprising:
a transparent gas detector tube containing a colorimetric chemical reagent within the transparent gas detector tube, wherein the colorimetric chemical reagent reacts with at least one of a target gas and an interferent to change the color of the colorimetric chemical reagent thereby producing a length of stain within the transparent tube corresponding to a concentration of either the target gas or the interferent gas in a sample;
a target gas length-of-stain scale to determine a concentration of the target compound in a sampled gas comprising the target gas for use with the transparent gas detector tube; and
an interferent gas length-of-stain scale to determine a concentration of the interferent compound in a sampled gas comprising the interferent gas for use with the transparent gas detector tube.

2. The gas detector tube kit of claim 1, wherein the target gas length-of-stain scale and the interferent gas length-of-stain scale are physical length-of-stain scales for visually determining the concentration of either the target gas or the interferent gas.

3. The gas detector tube kit of claim 1, further comprising a second target gas length-of-stain scale wherein the second target gas length-of-stain scale requires a different sample volume than the target gas length-of-stain scale to determine the concentration of the target gas.

4. The gas detector tube kit of claim 1, further comprising an electronic gas detector tube reader comprising an information storage device, wherein the target gas length of stain scale is stored electronically in the information storage device.

5. The gas detector tube kit of claim 4, wherein the interferent gas length of stain scale is stored electronically in the information storage device.

6. The gas detector tube kit of claim 4, wherein two or more interferent gas length of stain scales are stored electronically in the information storage device.

7. The gas detector tube kit of claim 6, wherein the two or more interferent gas length of stain scales each comprise different concentration ranges of the interferent gas.

8. The gas detector tube kit of claim 4, wherein the interferent gas length of stain scale determining a concentration of the interferent gas based upon electronic or optical reading of the length of stain.

9. The gas detector tube kit of claim 8, wherein the concentration of the interferent gas is output from the gas detector tube reader in at least one of percent, parts per million, parts per billion, pounds per million cubic feet, milligrams per cubic meter, and milligrams per liter.

10. The gas detector tube kit of claim 4, wherein the information stored in the information storage device includes at least one of the target gas compound, the target gas compound chemical formula, a scale, range and unit of measure of the interferent gas, a volume of a sample gas per pump stoke, a number of pump strokes required, a correction factor for each range, a sampling time for each range, a detection limit for the gas detector tube, a color change indication, a compensation factor for temperature and humidity, a standard deviation for the concentration determination, a shelf life for the gas detector tube, a reaction principle for the chemical reagent and the target gas, a reaction principle for the chemical reagent and the interferent gas, and an expiration date for the gas detector tube.

11. The gas detector tube kit of claim 4, further comprising a QR code or bar code for retrieving information including at least one of the target gas compound, the target gas compound chemical formula, a manufacturer of the gas detector tube, a part number of the gas detector tube, a lot number of the gas detector tube, a calibration scale of the gas detector tube, a detection limit for the gas detector tube, a unit of measure for the calibration scale, the measurement range of the gas detector tube, an expiration date for the gas detector tube, an environmental operating and storage specifications for temperature, humidity, altitude, barometric pressure, an effect of interferents, and correction factors, a volume of a sample gas per pump stoke, a standard number of pump strokes required, minimum detection limit, a sampling time for each pump stroke, a standard volume of a sample for the tube, sample time per pump stroke, total sample time, a correction factor for temperature and humidity, a lot specific calibration curve formula, and an identification if the QR code is dynamic or not dynamic, color change for the target gas, a color change for each interferent gas, relative standard deviation, calibration scale range and unit of measure for each target gas and interferent gas, each interferent gas name and chemical formula, an effect of each interferent gas, and an indication of whether the effect of each interferent gas is positive or negative.

12. The gas detector tube kit of claim 4, wherein the gas detector tube reader comprises a USB connection.

13. The gas detector tube kit of claim 4, wherein the gas detector tube reader comprises a communication device.

14. The gas detector tube kit of claim 13, wherein the communication device is one of a bar code reader, a USB connection, WIFI chip, Bluetooth, hard-wired ASCII communication port, optical signal reader, and infrared signal reader.

15. The gas detector tube kit of claim 4, wherein the gas detector tube reader is at least one of explosion proof and intrinsically safe.

16. A gas detector tube reader system, comprising:
a transparent gas detector tube containing a colorimetric chemical reagent within the transparent gas detector tube, wherein the colorimetric chemical reagent reacts with at least one of a target gas and an interferent to change the color of the colorimetric chemical reagent thereby producing a length of stain within the transparent tube corresponding to a concentration of either the target gas or the interferent gas in a sample;
a gas detector tube reader, comprising:
an information reader capable of identifying the transparent gas detector tube by reading electronic or optically coded tube information describing characteristics of the gas detector tube;
an optical reader capable of determining the length of stain in the gas detector tube, wherein the optical reader comprises a linear light source and a main light sensor capable of reading length-of-stain on the chemical reagent;
a computer memory device, wherein an interferent gas length-of-stain scale to determine a concentration of the interferent compound in a sampled gas from a length-of-stain in the transparent gas detector tube is stored in the computer memory device; and
a central processing unit in communication with the information reader and the optical reader, wherein the central processing unit is capable of estimating a concentration of target gases based upon output from the information reader and the optical reader.

17. The gas detector tube reader system of claim 16, wherein a target gas length-of-stain scale to determine a concentration of the interferent compound in a sampled gas from a length-of-stain in the transparent gas detector tube is stored in the computer memory device.

18. The gas detector tube reader system of claim 16, wherein the concentration of the interferent gas is output from the gas detector tube reader in at least one of percent, parts per million, parts per billion, pounds per million cubic feet, milligrams per cubic meter, and milligrams per liter.

19. The gas detector tube system of claim 16, wherein additional information stored in the computer memory device comprises at least one of the target gas compound, the target gas compound chemical formula, a scale, range and unit of measure of the interferent gas, a volume of a sample gas per pump stoke, a number of pump strokes required, a correction factor for each range, a sampling time for each range, a detection limit for the gas detector tube, a color change indication, a compensation factor for temperature and humidity, a standard deviation for the concentration determination, a shelf life for the gas detector tube, a reaction principle for the chemical reagent and the target gas, a reaction principle for the chemical reagent and the interferent gas, and an expiration date for the gas detector tube.

20. The gas detector tube system of claim 16, wherein the transparent gas detector tube or packaging for the gas detector tube comprises a QR code or bar code for retrieving tube information.

21. The gas detector tube system of claim 20, wherein the tube information comprises at least one of the target gas compound, the target gas compound chemical formula, a manufacturer of the gas detector tube, a part number of the gas detector tube, a lot number of the gas detector tube, a calibration scale of the gas detector tube, a detection limit for the gas detector tube, a unit of measure for the calibration scale, the measurement range of the gas detector tube, an expiration date for the gas detector tube, an environmental operating and storage specifications for temperature, humidity, altitude, barometric pressure, an effect of interferents, and correction factors, a volume of a sample gas per pump stoke, a standard number of pump strokes required, minimum detection limit, a sampling time for each pump stroke, a standard volume of a sample for the tube, sample time per pump stroke, total sample time, a correction factor for temperature and humidity, a lot specific calibration curve formula, and an identification if the QR code is dynamic or not dynamic, color change for the target gas, a color change for each interferent gas, relative standard deviation, calibration scale range and unit of measure for each target gas and interferent gas, each interferent gas name and chemical formula, an effect of each interferent gas, and an indication of whether the effect of each interferent gas is positive or negative.

22. The gas detector tube system of claim 16, wherein the gas detector tube reader comprises a USB connection.

23. The gas detector tube system of claim 16, wherein the gas detector tube reader comprises a communication device.

24. The gas detector tube system of claim 23, wherein the communication device is one of a bar code reader, a USB connection, WIFI chip, bluetooth, hard-wired ASCII communication port, optical signal reader, and infrared signal reader.

25. The gas detector tube system of claim 16, wherein the gas detector tube reader is at least one of explosion proof and intrinsically safe.
